(19) United States
(12) Patent Application Publication
(10) Pub. No.: US 2025/0240659 A1
(43) Pub. Date: Jul. 24, 2025

(54) COMMUNICATION METHOD AND COMMUNICATION APPARATUS FOR SENSING AND MEASUREMENT REPORTING

(71) Applicant: Beijing Xiaomi Mobile Software Co., Ltd., Beijing (CN)

(72) Inventor: Xiandong DONG, Beijing (CN)

(21) Appl. No.: 18/853,960

(22) PCT Filed: Apr. 7, 2022
(86) PCT No.: PCT/CN2022/085631

§ 371 Date: Oct. 3, 2024

(51) Int. Cl. H04W 24/10; H04W 84/12

(52) U.S. Cl. CPC H04W 24/10; H04W 84/12

(57) ABSTRACT

The present disclosure provides a communication method and a communication apparatus for sensing and measurement reporting. The communication method comprises: determining a sensing and measurement report frame, wherein the sensing and measurement report frame comprises time stamp information, the time stamp information identifying the reception time or transmission time of a sensing and measurement frame, the time stamp information being in one-to-one correspondence to the sensing and measurement report result; and transmitting to an access point device the sensing and measurement report frame.

### CROSS-REFERENCE TO RELATED APPLICATION

The application is a U.S. National Stage of International Application No. PCT/CN2022/085631 filed on Apr. 7, 2022, the entire content of which is incorporated herein by reference.

### TECHNICAL FIELD

The present disclosure relates to the field of wireless communications, and more particularly, to a communication method and communication apparatus for sensing measurement report.

### BACKGROUND

Wireless Local Area Network (WLAN) has the characteristics of flexibility, mobility and low cost. With the development of communication technology and the growth of user needs, the research on WLAN applications is gradually deepening. For example, WLAN sensing is currently being researched. Its main application scenarios are: location discovery in dense environments (home environment and enterprise environment), proximity detection, presence detection and detection of environment (for example, human actions, etc.), etc.

### SUMMARY

Various embodiments of the present disclosure provide the following technical solutions.

A communication method for sensing measurement report is provided according to an example embodiment of the present disclosure. The communication method is applied to a sensing receiver, and may include: determining a sensing measurement report frame, where the sensing measurement report frame includes timestamp information, where the timestamp information identifies a receiving time or a sending time of a sensing measurement frame, where the timestamp information corresponds one-to-one with a sensing measurement report result; and sending the sensing measurement report frame to an access point device.

A communication method for sensing measurement report is provided according to an example embodiment of the present disclosure. The communication method is applied to an access point device, and may include: receiving a sensing measurement report frame sent by a sensing receiver, where the sensing measurement report frame includes timestamp information, where the timestamp information identifies a receiving time or a sending time of a sensing measurement frame, where the timestamp information corresponds one-to-one with a sensing measurement report result; and obtaining the sensing measurement report result of the sensing receiver from the sensing measurement report frame.

A communication apparatus is provided according to an example embodiment of the present disclosure. The communication apparatus may include: a processing module configured to: determine a sensing measurement report frame, where the sensing measurement report frame includes timestamp information, where the timestamp information identifies a receiving time or a sending time of a sensing measurement frame, where the timestamp information corresponds one-to-one with a sensing measurement report result; and a transceiver module, configured to: send the sensing measurement report frame to an access point device.

A communication apparatus is provided according to an example embodiment of the present disclosure. The communication apparatus may include: a transceiver module configured to: receive a sensing measurement report frame sent by a sensing receiver, where the sensing measurement report frame includes timestamp information, where the timestamp information identifies a receiving time or a sending time of a sensing measurement frame, where the timestamp information corresponds one-to-one with a sensing measurement report result; and a processing module, configured to: obtain the sensing measurement report result of the sensing receiver from the sensing measurement report frame.

An electronic apparatus is provided according to an example embodiment of the present disclosure. The electronic device includes a memory, a processor, and a computer program stored on the memory and executable on the processor. The processor implements the methods as described above when executing the computer program.

A computer-readable storage medium is provided according to an example embodiment of the present disclosure. The computer program is stored on the computer-readable storage medium. The computer program, when executed by a processor, implements the methods described above.

The technical solutions provided by the example embodiments of the present disclosure improve the mechanism of sensing measurement report.

### BRIEF DESCRIPTION OF THE DRAWINGS

The above and other features of the embodiments of the present disclosure will be more apparent by describing in detail the example embodiments of the present disclosure with reference to the accompanying drawings, in which:

FIG. 1 is an exemplary manner illustrating WLAN sensing according to an example embodiment.

FIG. 2 is a flowchart illustrating a communication method according to an example embodiment.

FIG. 3 is a flowchart illustrating another communication method according to an example embodiment.

FIG. 4 is a block diagram illustrating a communication apparatus according to an example embodiment.

### DETAILED DESCRIPTION

The following description with reference to the accompanying drawings is provided to assist in a comprehensive understanding of various embodiments of the present disclosure as defined by the appended claims and their equivalents. Various embodiments of the present disclosure include various specific details, but these specific details are considered to be exemplary only. Additionally, descriptions of well-known techniques, functions, and constructions may be omitted for the sake of clarity and conciseness.

The terms and words used in the present disclosure are not limited to the written meanings, but, are merely used by the inventor to enable a clear and consistent understanding of the present disclosure. Accordingly, for those skilled in the art, the description of the various embodiments of the present disclosure is provided for illustration purpose only and not for purpose of limitation.

It should be understood that, as used herein, the singular forms “a/an,” “one,” “said” and “the” may include the plural forms as well, unless the context clearly dictates otherwise. It should be further understood that the word “include” as used in the present disclosure refers to the presence of the described features, integers, steps, operations, elements and/or components, but does not exclude the presence or addition of one or more other features, integers, steps, operations, elements, components and/or groups thereof.

It will be understood that, although the terms “first,” “second,” etc. may be used herein to describe various elements, these elements should not be limited by these terms. These terms are only used to distinguish one element from another. Accordingly, a first element discussed below may be referred to as a second element without departing from the teachings of example embodiments.

It should be understood that when an element is referred to as being “connected” or “coupled” to another element, it can be directly connected or coupled to the other element or an intervening element may also be present. Additionally, “connected” or “coupled” as used herein may include wireless connections or wireless couplings. As used herein, the term “and/or” or the expression “at least one/at least one of” includes any and all combinations of one or more of the associated listed items.

Unless otherwise defined, all terms (including technical and scientific terms) used herein have the same meaning as commonly understood by one of ordinary skill in the art to which the present disclosure belongs.

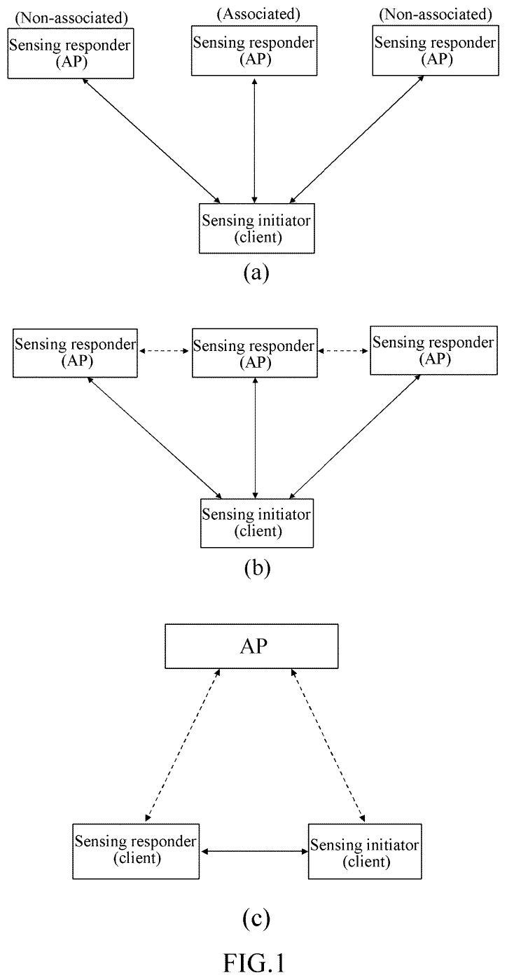

FIG. 1 is an exemplary manner illustrating WLAN sensing.

The process of WLAN sensing may be as follows: the initiator initiates WLAN sensing (for example, initiates a WLAN sensing session), and there may be multiple responders responding to it. The specific possible manners may be as shown in (a), (b) and (c) in FIG. 1.

Referring to (a) in FIG. 1, when a WLAN sensing initiator (e.g., a client) initiates WLAN sensing, multiple associated or unassociated WLAN sensing responders (e.g., three access points (APs)) can respond. “Associated” here may mean that an associated connection for communication has been established between the initiator and the responder, and “unassociated” may mean that no associated connection for communication has been established between the initiator and the responder.

As an example, client may include, but is not limited to: a cellular phone, a smartphone, a wearable device, a computer, a personal digital assistant (PDA), a personal communications system (PCS) device, a personal information manager (PIM), a personal navigation device (PND), a global positioning system, a multimedia device, an Internet of Things (IoT) device, etc.

AP may be a wireless switch used for a wireless network or an access device of a wireless network. AP may include software applications and/or circuits to enable other types of nodes in the wireless network to communicate with the outside and inside of the wireless network through AP. As an example, AP may be a terminal device or a network device equipped with a Wireless Fidelity (Wi-Fi) chip.

(b) in FIG. 1 is similar to (a) in FIG. 1, but in (b) in FIG. 1, communication may be conducted between individual responders (APs).

Referring to (c) in FIG. 1, both the WLAN sensing initiator and the WLAN sensing responder may be clients, and they may communicate by connecting to the same AP.

Although it is shown in (a), (b) and (c) in FIG. 1 that the client serves as the initiator and the AP serves as the responder, the present disclosure is not limited thereto. For example, in various embodiments of the present disclosure, the AP may serve as the initiator and the client may serve as the responder. In addition, in various embodiments of the present disclosure, the client may also be called a non-AP station (non-AP STA), referred to as a “station (STA)” for short. Furthermore, the numbers of the initiators and the responders are not limited to those shown in (a), (b) and (c) in FIG. 1.

As an illustrative embodiment, the procedure of WLAN sensing may include: WLAN sensing session setup, WLAN sensing measurement setup, and WLAN sensing measurement termination. In WLAN sensing session setup, an initiator (e.g., AP) may initiate a WLAN sensing session, a responder (e.g., STA) may respond to it, and an operating parameter(s) associated with the sensing session may be determined and exchanged between devices. One WLAN sensing session setup may contain one or more WLAN sensing measurement setups. That is, one or more WLAN sensing measurements may be set up between the initiator (e.g., AP) and the responder (e.g., STA). For example, each WLAN sensing measurement may utilize a corresponding measurement setup identifier (measurement setup ID) to identify. The WLAN sensing measurement corresponding to each measurement setup ID may include one or more WLAN sensing measurement events. The sensing measurement may be performed for each WLAN sensing measurement event. In each WLAN sensing measurement event, a transmitter may send a sensing measurement frame, and a receiver may use the received sensing measurement frame to perform sensing measurement. The transmitter that sends the sensing measurement frame may be the initiator or the responder. Correspondingly, the receiver that receives the sensing measurement frame may be the responder or the initiator. For example, in some embodiments, the transmitter that sends the sensing measurement frame may be an AP, and the receiver may be an STA. In this case, the receiver STA may report the sensing measurement result to the transmitter AP. In WLAN sensing measurement termination, the device stops performing measurements and terminates the sensing session.

The receiver may report the sensing measurement result to the transmitter through the sensing measurement report frame, and the receiver may perform sensing measurement report for multiple sensing measurement events at the same time. For example, multiple sensing measurement reports may be aggregated in a single frame for transmission. However, in the current study, the mechanism for sensing measurement report is not yet complete, for example, there is a lack of clear definition of the sensing measurement report frame.

In view of this, a communication method and a communication apparatus for sensing measurement report are provided according to concepts of the embodiments of the present disclosure.

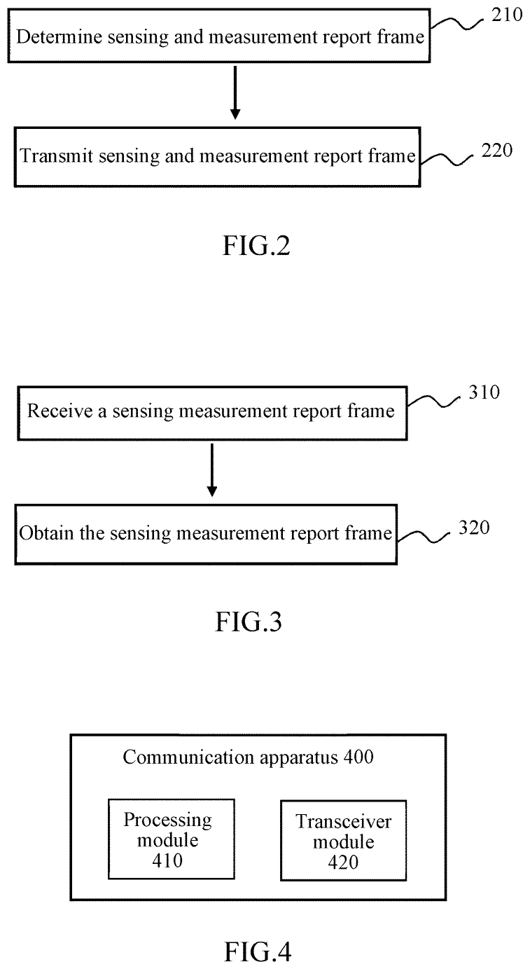

FIG. 2 is a flowchart illustrating a communication method according to an example embodiment. The communication method shown in FIG. 2 may be applied to a WLAN sensing receiver (e.g., STA). In the following, the WLAN sensing receiver may also be referred to as the “sensing receiver (or receiver)” for short.

In the embodiments of the present disclosure, the sensing receiver (or receiver) may be a station that receives the sensing measurement frame during the WLAN sensing measurement procedure. The sensing receiver (or receiver) may perform sensing measurement based on the received sensing measurement frame, and feed back the sensing measurement report result to the access point device by sending a sensing measurement report frame. For example, as a descriptive embodiment only, the sensing measurement frame may be a Null Data Packet (NDP) frame. For example, the NDP frame may include operating parameters required to perform WLAN sensing measurement, such as the number of spatial streams, an operation bandwidth of the NDP frame, a long training field (LTF), a packet extension field (packet extension, PE), etc. However, the present disclosure is not limited thereto, and other frames carrying information for WLAN sensing measurement are also feasible.

Referring to FIG. 2, in step 210, the sensing receiver may determine the sensing measurement report frame; in step 220, the sensing receiver may send the sensing measurement report frame to the access point device. According to the embodiments of the present disclosure, the sensing measurement report frame may include timestamp information, where the timestamp information may identify a receiving time or sending time of the sensing measurement frame (e.g., NDP frame). For example, the timestamp information may correspond to a sensing measurement event, indicating a time when a sender sends a sensing measurement frame (e.g., an NDP frame) or a time when a receiver receives a sensing measurement frame in the corresponding sensing measurement event. In the embodiments of the present disclosure, the sensing measurement report frame may include timestamp information, so that a sensing measurement report with relatively high time requirements can be better provided. According to the embodiments described above, multiple sensing measurement reports may be aggregated and transmitted in one frame. In order to better reflect the result of each sensing measurement event or sensing measurement procedure, the timestamp information may need to be included in each measurement report. In other words, in the sensing measurement report frame, the timestamp information may correspond to the sensing measurement report result one-to-one. For example, the sensing measurement report result may refer to channel state information (CSI), but the present disclosure is not limited thereto.

The sensing measurement report frame may contain various information about the sensing measurement report. For example, the information may be carried through a sensing measurement report element, as Table 1 below, which shows the format of the sensing measurement report element of the sensing measurement report frame.

TABLE 1
Format of sensing measurement report element

| | | | | Sensing | Sensing | Sensing |
|---|---|---|---|---|---|---|
| | | | Element ID | Measurement | Measurement | Measurement |
| | Element ID | Length | Extension | Report Type | Report Control | Report |
| Octet | 1 | 1 | 1 | To be determined | To be determined | Variable |

In Table 1, the element identification (Element ID) field, the Length field and the Element ID Extension field may respectively be an identification, length and extensible information about the sensing measurement report element. The Sensing Measurement Report Type field may be used to identify a type of the sensing measurement report result carried in the Sensing Measurement Report field. For example, the type may be identified as CSI. The Sensing Measurement Report Control field may contain information necessary to interpret the Sensing Measurement Report field. The Sensing Measurement Report field may contain information related to the sensing measurement report result. The Sensing Measurement Report Control field and the Sensing Measurement Report field will be described respectively in various embodiments below.

It will be understood that Table 1 is a descriptive embodiment only and is not a limitation of the present disclosure. The number of Octets of each field in Table 1 is only exemplary, and it may be modified differently as needed. In addition, it can be understood that each element shown in Table 1 exists independently. These elements are exemplarily listed in the same table, but it does not mean that all elements in the table must exist simultaneously as shown in the table. The value of each element does not depend on the value of any other element in Table 1. Therefore, those skilled in the art can understand that the value of each element in the table of the present disclosure is an independent embodiment.

According to the embodiments of the present disclosure, the sensing measurement report frame may include a sensing measurement report field, and timestamp information may be included in the sensing measurement report field. In addition, the sensing measurement report result corresponding to the timestamp information may also be included in the sensing measurement report field.

According to another embodiment of the present disclosure, the sensing measurement report frame may further include a sensing measurement report control field. The sensing measurement report control field may contain information necessary to interpret the sensing measurement report field. The sensing measurement report control field may have multiple subfields.

In an embodiment of the present disclosure, the sensing measurement report control field may include a first subfield used to identify that the sensing measurement report frame includes timestamp information. The first subfield may be a timestamp information identification subfield, which may identify that the sensing measurement report frame contains timestamp information. Specifically, the first subfield has at least one bit to identify the number of pieces of the timestamp information. That is, the sensing measurement report field of the sensing measurement report frame may contain one or more pieces of timestamp information, and the first subfield of the sensing measurement report control field may identify the number of pieces of the timestamp information in the sensing measurement report field. That is, the number of pieces of the timestamp information in the sensing measurement report field may correspond to the number identified by the first subfield. For example, but it is not limited that the first subfield of the sensing measurement report control field may have 4 bits, indicating that the sensing measurement report frame may carry up to 16 pieces of timestamp information. In an embodiment of the present disclosure, the sensing measurement report control field may include a subfield (i.e., a first subfield) for interpreting that the sensing measurement report field includes the timestamp information, which is helpful to the AP that receives the sensing measurement report frame to parse the frame more accurately (for example, parse the sensing measurement report field), thereby obtaining an accurate sensing measurement report result.

In another embodiment of the present disclosure, the sensing measurement report control field may further include a second subfield used to identify a measurement setup identifier, where the measurement setup identifier corresponds to the first subfield. Corresponding the measurement setup identifier to the first subfield can clearly identify the number of pieces of the timestamp information of the measurement event in each measurement setup identifier, which helps the AP to accurately parse the sensing measurement report frame. For example, the sensing measurement report control field may include a plurality of first subfields, and may include second subfields corresponding to respective first subfields, as shown in Table 2 below.

TABLE 2

| | | | | |
|---|---|---|---|---|
| Measurement | Number of | Measurement | Number of | . . . |
| setup ID 1 | Timestamp 1 | setup ID 2 | Timestamp 2 | |

Referring to Table 2, Number of Timestamp 1, Number of Timestamp 2, etc. may represent the first subfield, and Measurement setup ID 1, Measurement setup ID 2, etc. may represent the second subfield. Measurement setup ID 1 corresponds to Number of Timestamp 1, indicating that the number of pieces of the timestamp information of the sensing measurement frame corresponding to Measurement setup ID 1 is the value identified by Number of Timestamp 1; Measurement setup ID 2 corresponds to Number of Timestamp 2, indicating that the number of pieces of the timestamp information of the sensing measurement frame corresponding to Measurement setup ID 2 is the value identified by Number of Timestamp 2.

Although it is shown in the above embodiments and Table 2 that the sensing measurement report control field may include a second subfield used to identify the measurement setup identifier, in other embodiments of the present disclosure, such a second subfield may not be included. For example, the sender or initiator may record the time it sends a sensing measurement frame (NDP frame) without including the measurement setup identifier.

According to another embodiment of the present disclosure, in the case of non-trigger-based sensing measurement (Non-TB sensing measurement), the sensing measurement report frame may further include an address of the sensing receiver. Non-TB sensing measurement may refer to that the station sends a Null Data Packet Announcement (NDPA) frame to the AP for sensing measurement procedure, which is uplink or downlink sensing measurement, or both coexist. The sensing receiver address (RA) included in the sensing measurement report frame may identify which STA sent the measurement report frame. The AP may receive the sensing measurement report frames from a plurality of STAs at the same time, and the sensing receiver address (RA) allows the AP to accurately know which STA sent the received sensing measurement report frame.

According to another embodiment of the present disclosure, in the case of trigger-based sensing measurement (TB-based sensing measurement), the sensing measurement report frame may further include an identifier of the sensing receiver. TB-based sensing measurement may refer to the need for a trigger frame to participate in the sensing measurement procedure (for example, the trigger frame participates in at least one stage, such as polling, measurement, and feedback). In the embodiments of the present disclosure, the identifier of the sensing receiver may be identified by an AID or a UID. The AID may represent an identifier of a station that has established associated communication with the AP, and the UID may represent an identifier of a station that has not established associated communication with the AP. The identifier AID or UID of the sensing receiver can identify each sensing receiver and correspond one-to-one with the sensing measurement report frame.

The embodiments of the present disclosure clearly define the sensing measurement report frame to improve the mechanism of the sensing measurement report.

Although the information contained in the sensing measurement report frame is described above with reference to various embodiments, these are merely descriptive embodiments and are not limitations of the present disclosure. Various variations and modifications may be made to the various embodiments.

The embodiments of the present disclosure may provide a communication method for determining a sensing measurement report frame, and the communication method may be applied to a sensing receiver (e.g., STA). The communication method may include: determining a sensing measurement report control field of a sensing measurement report frame, where the sensing measurement report control field may include a subfield used to identify that the sensing measurement report frame includes timestamp information. The timestamp information may identify a receiving time or sending time of a sensing measurement frame, and this subfield may identify the number of pieces of the timestamp information.

The embodiments of the present disclosure may also provide a communication method for determining a sensing measurement report frame, and the communication method may be applied to a sensing receiver (e.g., STA). The communication method may include: determining a sensing measurement report control field of a sensing measurement report frame, where the sensing measurement report control field may include a subfield used to identify a measurement setup identifier.

The embodiments of the present disclosure may also provide a communication method for determining a sensing measurement report frame, and the communication method may be applied to a sensing receiver (e.g., STA). The communication method may include: determining a sensing measurement report field of a sensing measurement report frame, where the sensing measurement report field may include timestamp information. The timestamp information may identify a receiving time or sending time of a sensing measurement frame, and the timestamp information corresponds to a sensing measurement report result one-to-one.

The embodiments of the present disclosure may also provide a communication method for determining a sensing measurement report frame, and the communication method may be applied to a sensing receiver (e.g., STA). The communication method may include: determining an address or identifier of a sensing receiver. For example, in the case of Non-TB sensing measurement, the sensing measurement report frame includes the address of the determined sensing receiver (RA). In the case of TB-based sensing measurement, the sensing measurement report frame includes the determined identifier (AID/UID) of the sensing receiver.

FIG. 3 is a flowchart illustrating another communication method according to an example embodiment. The communication method shown in FIG. 3 may be applied to an access point device (hereinafter may be referred to as “AP” for short).

Referring to FIG. 3, in step 310, the access point device may receive a sensing measurement report frame sent by the sensing receiver (e.g., STA), where the sensing measurement report frame may include timestamp information, the timestamp information may identify a receiving time or sending time of a sensing measurement frame (for example, NDP frame), and the timestamp information may correspond one-to-one with a sensing measurement report result.

According to an embodiment of the present disclosure, the sensing measurement report frame may further include: a sensing measurement report control field, where the sensing measurement report control field may include a first subfield for identifying that the sensing measurement report frame includes timestamp information.

According to an embodiment of the present disclosure, the first subfield may have at least one bit to identify the number of pieces of the timestamp information.

According to an embodiment of the present disclosure, the sensing measurement report frame may further include a sensing measurement report field, where the timestamp information may be included in the sensing measurement report field, and the number of pieces of the timestamp information in the sensing measurement report field may correspond to the number identified by the first subfield.

According to an embodiment of the present disclosure, the sensing measurement report control field may further include a second subfield for identifying a measurement setup identifier, where the measurement setup identifier may correspond to the first subfield.

According to an embodiment of the present disclosure, in the case of non-trigger-based sensing measurement, the sensing measurement report frame may further include an address of the sensing receiver.

According to an embodiment of the present disclosure, in the case of trigger-based sensing measurement, the sensing measurement report frame may further include an identifier of the sensing receiver.

In step 320, the access point device may obtain the sensing measurement report result of the sensing receiver from the sensing measurement report frame. For example, the AP may parse the sensing measurement report frame. For example, it may accurately parse the sensing measurement report frame by referring to the sensing measurement report control field, thereby obtaining the sensing measurement report result corresponding to each timestamp information.

Specific descriptions of the sensing measurement report frame, the sensing measurement report control field, the sensing measurement report field, the first subfield, the second subfield, etc. have been described in detail in the foregoing embodiments and will not be repeated here.

The embodiments of the present disclosure clearly define the sensing measurement report frame to improve the mechanism of the sensing measurement report.

Although the information contained in the sensing measurement report frame is described above with reference to various embodiments, these are merely descriptive embodiments and are not limitations of the present disclosure. Various variations and modifications may be made to the various embodiments.

The embodiments of the present disclosure may provide a communication method for sensing measurement report, and the communication method may be applied to an access point device. The communication method may include: receiving a sensing measurement report frame sent by a sensing receiver (e.g., STA), where the sensing measurement report frame may include a sensing measurement report control field, and the sensing measurement report control field may include a subfield used to identify that the sensing measurement report frame includes timestamp information. The timestamp information may identify the receiving time or sending time of a sensing measurement frame, and this subfield may identify the number of pieces of the timestamp information.

The embodiments of the present disclosure may further provide a communication method for sensing measurement report, and the communication method may be applied to an access point device. The communication method may include: receiving a sensing measurement report frame sent by a sensing receiver (e.g., STA), where the sensing measurement report frame may include a sensing measurement report control field, and the sensing measurement report control field may include a subfield used to identify a measurement setup identifier.

The embodiments of the present disclosure may further provide a communication method for sensing measurement report, and the communication method may be applied to an access point device. The communication method may include: receiving a sensing measurement report frame sent by a sensing receiver (e.g., STA), where the sensing measurement report frame may include a sensing measurement report field, and the sensing measurement report field may include timestamp information. The timestamp information may identify the receiving time or sending time of the sensing measurement frame, and the timestamp information corresponds to the sensing measurement report result one-to-one.

The embodiments of the present disclosure may further provide a communication method for sensing measurement report, and the communication method may be applied to an access point device. The communication method may include: receiving a sensing measurement report frame sent by a sensing receiver (e.g., STA). For example, in the case of Non-TB sensing measurement, the sensing measurement report frame includes the address (RA) of the sensing receiver. In the case of TB-based sensing measurement, the sensing measurement report frame includes an identifier (AID/UID) of the sensing receiver.

According to the communication method of the embodiment of the present disclosure, the sensing measurement report frame is clearly defined, the sensing measurement report mechanism is improved, and the measurement report with high time requirements can be better provided.

FIG. 4 is a block diagram illustrating a communication apparatus according to an example embodiment. The communication apparatus 400 of FIG. 4 may include a processing module 410 and a transceiver module 420. In an embodiment of the present disclosure, the communication apparatus 400 shown in FIG. 4 may be applied to a sensing receiver (e.g., STA). In another embodiment of the present disclosure, the communication apparatus 400 shown in FIG. 4 may be applied to the access point device (i.e., AP).

In the case where the communication apparatus 400 shown in FIG. 4 may be applied to a sensing receiver (e.g., STA), the processing module 410 may be configured to: determine a sensing measurement report frame, where the sensing measurement report frame may include timestamp information. The timestamp information may identify the receiving time or sending time of the sensing measurement frame, and the timestamp information may correspond one-to-one with the sensing measurement report results. The transceiver module 420 may be configured to: send the sensing measurement report frame to the access point device. That is to say, the communication apparatus 400 shown in FIG. 4 may perform the communication method described with reference to FIG. 2, and the embodiment described in conjunction with FIG. 2 and the various embodiments described with reference to Table 1 and Table 2 may be applied thereto. In order to avoid redundancy, repeated descriptions are omitted here.

In the case where the communication apparatus 400 shown in FIG. 4 may be applied to AP, the transceiver module 420 may be configured to: receive a sensing measurement report frame sent by the sensing receiver, where the sensing measurement report frame may include timestamp information. The timestamp information may identify the receiving time or sending time of the sensing measurement frame, and the timestamp information may correspond one-to-one with the sensing measurement report result. The processing module 410 may be configured to: obtain the sensing measurement report result of the sensing receiver from the sensing measurement report frame. That is to say, the communication apparatus 400 shown in FIG. 4 can perform the communication method described with reference to FIG. 3, and the embodiments described with reference to Table 1 and Table 2 can be applied thereto. In order to avoid redundancy, repeated descriptions are omitted here.

It will be understood that the communication apparatus 400 shown in FIG. 4 is only exemplary, and the embodiments of the present disclosure are not limited thereto. For example, the communication apparatus 400 may also include other module(s), such as a memory module and the like. Furthermore, individual modules in the communication apparatus 400 may be combined into a more complex module(s), or may be divided into more separate modules.

The communication method and communication apparatus according to the embodiments of the present disclosure clearly define the sensing measurement report frame, improve the sensing measurement report mechanism, and can better provide measurement reports with high time requirements.

Based on the same principles as the methods provided by the embodiments of the present disclosure, the embodiments of the present disclosure further provide an electronic apparatus. The electronic apparatus includes a processor and a memory. The memory stores machine-readable instructions (may also be referred to as a “computer program”). The processor is configured to execute the machine-readable instructions to implement the methods described with reference to FIGS. 2 and 3.

The embodiments of the present disclosure further provide a computer-readable storage medium having a computer program stored on the computer-readable storage medium. When the computer program is executed by a processor, the methods described with reference to FIG. 2 and FIG. 3 are implemented.

In an example embodiment, the processor may be used to implement or execute various exemplary logical blocks, modules and circuits described in conjunction with the present disclosure, such as a Central Processing Unit (CPU), a general-purpose processing unit, a Digital Signal Processor (DSP), an Application Specific Integrated Circuit (ASIC), a Field Programmable Gate Array (FPGA) or other programmable logic devices, transistor logic devices, hardware components or any combination thereof. The processor may also be a combination that implements computing functions, such as a combination containing one or more microprocessors, a combination of a DSP and a microprocessor, etc.

In an example embodiment, the memory may be, for example, a Read Only Memory (ROM), a Random Access Memory (RAM), an Electrically Erasable Programmable Read Only Memory (EEPROM), a Compact Disc Read Only Memory (CD-ROM), or other optical disk storage, optical disc storage (including compressed optical discs, laser discs, optical discs, digital versatile discs, Blu-ray discs, etc.), magnetic disk storage media or other magnetic storage device, or any other medium that can be used to carry or store the program code in the form of instructions or data structures that can be accessed by a computer, but is not limited thereto.

It should be understood that although various steps in the flowchart of the accompanying drawings are shown in sequence as indicated by arrows, these steps are not necessarily performed in the order indicated by the arrows. Unless explicitly stated in the present disclosure, the execution of these steps is not strictly limited in order, and they can be executed in other orders. In addition, at least some of the steps in the flowchart of the accompanying drawings may include multiple sub-steps or multiple stages. These sub-steps or stages are not necessarily executed at the same time, but may be executed at different times, and their execution order does not necessarily need to be performed sequentially, but may be performed in turn or alternately with other steps or sub-steps of other steps or at least part of the stages.

Although the present disclosure has been shown and described with reference to certain embodiments thereof, those skilled in the art will understand that various changes may be made in form and detail without departing from the scope of the present disclosure. Therefore, the scope of the present disclosure should not be limited to the embodiments, but should be defined by the appended claims and their equivalents.

1. A communication method for sensing measurement report, applied to a sensing receiver, comprising:
determining a sensing measurement report frame, wherein the sensing measurement report frame comprises timestamp information, wherein the timestamp information identifies a receiving time or a sending time of a sensing measurement frame, and the timestamp information corresponds one-to-one with a sensing measurement report result; and
sending the sensing measurement report frame to an access point device.

2. The communication method according to claim 1, wherein the sensing measurement report frame further comprises: a sensing measurement report control field, wherein the sensing measurement report control field comprises a first subfield to identify that the sensing measurement report frame comprises the timestamp information.

3. The communication method according to claim 2, wherein the first subfield has at least one bit to identify a number of pieces of the timestamp information.

4. The communication method according to claim 3, wherein the sensing measurement report frame further comprises a sensing measurement report field, wherein the timestamp information is comprised in the sensing measurement report field, and wherein a number of pieces of the timestamp information in the sensing measurement report field corresponds to the number identified by the first subfield.

5. The communication method according to claim 2, wherein the sensing measurement report control field further comprises a second subfield to identify a measurement setup identifier, wherein the measurement setup identifier corresponds to the first subfield.

6. The communication method according to claim 1, wherein in a case of non-trigger-based sensing measurement, the sensing measurement report frame further comprises an address of the sensing receiver.

7. The communication method according to claim 1, wherein in a case of trigger-based sensing measurement, the sensing measurement report frame further includes an identifier of the sensing receiver.

8. A communication method for sensing measurement report, applied to an access point device, comprising:
receiving a sensing measurement report frame sent by a sensing receiver, wherein the sensing measurement report frame comprises timestamp information, wherein the timestamp information identifies a receiving time or a sending time of a sensing measurement frame, wherein the timestamp information corresponds one-to-one with a sensing measurement report result; and
obtaining the sensing measurement report result of the sensing receiver from the sensing measurement report frame.

9. The communication method according to claim 8, wherein the sensing measurement report frame further comprises: a sensing measurement report control field, wherein the sensing measurement report control field comprises a first subfield to identify that the sensing measurement report frame comprises the timestamp information.

10. The communication method according to claim 9, wherein the first subfield has at least one bit to identify a number of pieces of the timestamp information.

11. The communication method according to claim 10, wherein the sensing measurement report frame further comprises a sensing measurement report field, wherein the timestamp information is comprised in the sensing measurement report field, and wherein a number of pieces of the timestamp information in the sensing measurement report field corresponds to the number identified by the first subfield.

12. The communication method according to claim 9, wherein the sensing measurement report control field further comprises a second subfield to identify a measurement setup identifier, wherein the measurement setup identifier corresponds to the first subfield.

13. The communication method according to claim 8, wherein in a case of non-trigger-based sensing measurement, the sensing measurement report frame further comprises an address of the sensing receiver.

14. The communication method according to claim 8, wherein in a case of trigger-based sensing measurement, the sensing measurement report frame further comprises an identifier of the sensing receiver.

15. A communication apparatus, comprising:
a processor; and
a memory storing instructions executable by the processor;
wherein the processor is configured to:
determine a sensing measurement report frame, wherein the sensing measurement report frame comprises timestamp information, wherein the timestamp information identifies a receiving time or a sending time of a sensing measurement frame, wherein the timestamp information corresponds one-to-one with a sensing measurement report result; and
send the sensing measurement report frame to an access point device.

16. A communication apparatus, comprising:
a processor; and
a memory storing instructions executable by the processor:
wherein the processor is configured to: perform the method according to claim 8.

17. (canceled)

18. (canceled)

19. The communication apparatus according to claim 15, wherein the sensing measurement report frame further comprises: a sensing measurement report control field, wherein the sensing measurement report control field comprises a first subfield to identify that the sensing measurement report frame comprises the timestamp information.

20. The communication apparatus according to claim 19, wherein the first subfield has at least one bit to identify a number of pieces of the timestamp information.

21. The communication apparatus according to claim 20, wherein the sensing measurement report frame further comprises a sensing measurement report field, wherein the timestamp information is comprised in the sensing measurement report field, and wherein a number of pieces of the timestamp information in the sensing measurement report field corresponds to the number identified by the first subfield.

22. The communication apparatus according to claim 19, wherein the sensing measurement report control field further comprises a second subfield to identify a measurement setup identifier, wherein the measurement setup identifier corresponds to the first subfield.
